(19) United States
(12) Patent Application Publication
(10) Pub. No.: US 2025/0117459 A1
(43) Pub. Date: Apr. 10, 2025

(54) SYSTEMS AND METHODS FOR DYNAMICALLY GENERATING DIGITAL RIGHTS MANAGEMENT PROTECTIONS

(71) Applicant: Capital One Services, LLC, McLean, VA (US)

(72) Inventors: Ian KATZMAN, Herndon, VA (US); Tyler MAIMAN, Melville, NY (US); Joshua EDWARDS, Philadelphia, PA (US); Shahalam BAIG, Rochester, NY (US); Jackson WESTWOOD, New York, NY (US); Shasanka BHANDARI, McLean, VA (US); Matthew HUNSBERGER, Hoboken, NJ (US)

(73) Assignee: Capital One Services, LLC, McLean, VA (US)

(21) Appl. No.: 18/905,170

(22) Filed: Oct. 3, 2024

Related U.S. Application Data
(60) Provisional application No. 63/587,891, filed on Oct. 4, 2023.
(60) Provisional application No. 63/665,485, filed on Jun. 28, 2024.
(60) Provisional application No. 63/683,063, filed on Aug. 14, 2024.

(51) Int. Cl. G06F 21/10

(52) U.S. Cl. CPC G06F 21/107

(57) ABSTRACT

Disclosed are systems and methods for dynamically generating digital rights management (“DRM”) protections, including receiving an indication of digital extraction associated with first sensitive information, determining an identity of an application associated with the indication of digital extraction, determining a mode associated with the indication of digital extraction, and based on the determined identity of the application and the determined mode of the digital extraction, transmitting a first alert to a DRM-protection system.

### CROSS-REFERENCE TO RELATED APPLICATION(S)

This application claims the benefit of pending U.S. Provisional Patent Application No. 63/587,891, filed on Oct. 4, 2023, pending U.S. Provisional Patent Application No. 63/665,485, filed on Jun. 28, 2024, and pending U.S. Provisional Patent Application No. 63/683,063, filed on Aug. 14, 2024, all of which are incorporated herein by reference in their entireties.

### TECHNICAL FIELD

Various embodiments of this disclosure relate generally to dynamically generating digital rights management (“DRM”) protections and, more particularly, to systems and methods for dynamically generating DRM protections based on an identity or mode of predicted digital extraction.

### BACKGROUND

Organizations such as banks and healthcare providers seek to protect sensitive or confidential information (e.g., personally identifiable information (PII), financial information, medical information, etc.) from social engineers. A social engineer is a person or entity who seeks to manipulate a target (e.g., a customer or employee of an organization) into divulging sensitive information that may be used for fraudulent purposes. That is, a social engineer is a person or entity who engages in social engineering. For example, the target may be a user who uses a desktop computer including a display screen (also referred to herein as a “screen”) to log into a bank's website and then view an account number on the website. The bank's website may be presented using a browser A on the display screen. A social engineer using another computing device may attempt to persuade the user to reveal the account number to the social engineer. More specifically, the social engineer may convince the user to (i) share the user's screen (displaying the account number) with the social engineer using a screen sharing or remote desktop application, or (ii) take a screenshot of the user's screen (displaying the account number) using a screenshotting application, and then transmit the screenshot to the social engineer.

To guard against such social engineering, the bank may employ digital rights management (DRM) technologies (e.g., technologies that limit the use of digital content). While DRM technologies aid in protecting sensitive information, a social engineer may still attempt digital extraction of the sensitive information. In such a scenario, conventional methods may fail to determine the means by which digital extraction may be occurring.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for dynamically generating DRM protections.

In one aspect, a method for dynamically generating digital rights management (“DRM”) protections is disclosed. The method may include receiving, via an application server, an indication of digital extraction associated with first sensitive information, wherein the first sensitive information and a first DRM-protected media having been caused to be displayed via a graphical user interface (“GUI”) and each are associated with a first DRM-protected content element, determining, via an application server, an identity of an application associated with the indication of digital extraction, determining, via an application server, a mode associated with the indication of digital extraction, wherein the mode includes at least one of screensharing, screen shotting, or screen capture, and based on the determined identity of the application and the determined mode of the digital extraction, transmitting a first alert to a DRM-protection system.

In another aspect, a system is disclosed. The system may include at least one memory storing instructions and at least one processor operatively connected to the memory, and configured to execute the instructions to perform operations for dynamically generating digital rights management (“DRM”) protections. The operations may include receiving, via an application server, an indication of digital extraction associated with first sensitive information, wherein the first sensitive information and a first DRM-protected media having been caused to be displayed via a graphical user interface (“GUI”) and each are associated with a first DRM-protected content element, determining, via an application server, an identity of an application associated with the indication of digital extraction, determining, via an application server, a mode associated with the indication of digital extraction, wherein the mode includes at least one of screensharing, screen shotting, or screen capture, and based on the determined identity of the application and the determined mode of the digital extraction, transmitting a first alert to a DRM-protection system.

In another aspect, a method for dynamically generating digital rights management (“DRM”) protections is disclosed. The method may include receiving, via an application server, an indication of digital extraction associated with first sensitive information, wherein the first sensitive information and a first DRM-protected media having been caused to be displayed via a graphical user interface (“GUI”) are associated with a first DRM-protected content element, determining, via an application server, an identity of an application associated with the indication of digital extraction, determining, via an application server, a mode associated with the indication of digital extraction, wherein the mode of digital extraction includes at least one of screensharing, screen shotting, or screen capture, based on the determined mode of digital extraction, modifying the first DRM-protected content element such that the first DRM-protected media is made substantially opaque or stops playing via the application server, based on the determined identity of the application and the determined mode of the digital extraction, transmitting a first alert to a DRM-protection system and a second alert to a user device, based on the first alert, implementing at least one protective action via the DRM-protection system, and causing to output, via a GUI associated with the user device, the modified first DRM-protected media and the second alert.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for dynamically generating DRM protections, according to one or more embodiments.

FIG. 2 depict exemplary methods for dynamically generating DRM protections, according to one or more embodiments.

FIG. 3 depicts a simplified functional block diagram of a computer, according to one or more embodiments.

### DETAILED DESCRIPTION OF EMBODIMENTS

Reference to any particular activity is provided in this disclosure only for convenience and not intended to limit the disclosure. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “about,” “approximately,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The term “user” or the like may refer to a person authorized to access an account, attempting to access an account, etc. As used herein, the term “social engineer” may be a person or entity who seeks to manipulate a target (e.g., a customer or employee of an organization) into divulging sensitive information that may be used for fraudulent purposes. That is, a social engineer is a person or entity who engages in social engineering.

As used herein, the phrase “media content” may represent a browser, a website, a webpage, etc. As used herein, the phrase “content element” may represent text data (e.g., letters, numbers, symbols, metadata, or alt text), image data (e.g., an image, a graphic, a sequence of image frames, or a video), audio data (e.g., a sequence of audio frames), or video data (e.g., a sequence of image frames). Further, a content element may represent data included in, or referred by, an HTML element of an HTML page corresponding to (or representing) the webpage. For example, a content element may be included in HTML used to structure the website, such as a Document Object Model (“DOM”), Cascading Style Sheets (“CSS”), etc. In some aspects, the content element may include or represent sensitive or confidential information (e.g., that may be displayed on a webpage (or webpage(s), website(s), portal(s) or application(s), etc.).

As used herein, the phrase “sensitive information” or “sensitive data” may refer to data that is intended for, or restricted to the use of, one or more users or entities (e.g., the user 105 and an organization associated with the application server 125). Moreover, sensitive data may represent data that is personal, private, confidential, privileged, secret, classified, or in need of protection, for example. Sensitive information may include personally identifiable information (“PII”) (e.g., a name, an address, a phone number, a social security number, etc.), financial information (e.g., an account number, an account balance, debits, credits, etc.), medical information (e.g., test results, appointments, medications, etc.), business information (e.g., proprietary information, trade secrets, etc.), government information (e.g., classified or secret information), any information a user may wish to not be shared with a third party, etc.

The phrase “hypertext markup language,” “HTML,” or the like may refer to a standardized system for tagging text files to achieve font, color, graphic, or hyperlink effects on World Wide Web pages. The phrase “HTML element” may represent a component of an HTML page, and may include, for example, a start tag and end tag, and as noted above, a content element or a reference to a content element (e.g., link, hyperlink, address, or path to a content element). Further, in some embodiments, an HTML element may include one or more HTML elements (e.g., nested HTML elements). As used herein, the term “pixel” may refer to the smallest element (or unit) of a display screen that can be programmed by (or manipulated through) software. In some embodiments, a pixel may include sub-pixels (e.g., a red sub-pixel, a green sub-pixel, and a blue sub-pixel) that emit light to create a color displayed on the display screen. In some aspects, the color may be included in, or represent, text data, image data, or video data presented on the display screen.

As used herein, the phrase “digital extraction” may refer to any process of copying content (e.g., audio, video, text, image, etc.), such as ripping, screensharing, screenshotting, etc. As used herein, the term “screenshare” or “screen share” may refer to a real time or near real time electronic transmission of data displayed on a display screen of a user's computing device to one or more other computing devices. The term “screensharing” or “screen sharing” and the phrase “being screenshared” or “being screen shared” may refer to performing a screenshare. In some aspects, screensharing may be performed using a screensharing application (e.g., a video or web conferencing application such as Zoom®, Microsoft's Teams®, or the like, or a remote desktop application such as Microsoft Remote Desktop, Chrome Remote Desktop, or the like). As used herein, the term “screenshot” or “screen shot” may represent an image of data displayed on a display screen of a computing device, where the image may be captured or recorded. The term “screenshotting” or “screen shotting” and the phrase “being screenshotted” or “being screen shotted” may refer to capturing or recording a screenshot. In some aspects, screenshotting may be performed using a screenshotting application (e.g., the Snipping Tool in Microsoft's Windows 11 or an application accessed using a Print Screen key of a keyboard or keypad).

In an exemplary use case, aspects of the present disclosure relate to systems and methods for protecting one or more content elements associated with a webpage of a website, e.g., via dynamically generating DRM protections. For example, a system may comprise at least one memory storing instructions, and at least one processor operatively connected to the at least one memory and configured to execute the instructions to perform operations for protecting a content element based on case-specific data. In some aspects, the content element may represent sensitive or confidential information. The operations may include detecting, using an application server, that a user has logged into the website using a first browser on a computing device. In some aspects, the first browser may be configured to support DRM technologies (e.g., to protect the content element from being transmitted to a social engineer via screensharing or screenshotting). The operations may further include detecting, using the application server and subsequent to the user logging into the website using the first browser, that the user has logged into the website using a second browser on the computing device. In some aspects, the second browser may not be configured to support DRM technologies. The operations may further include determining, using the application server, whether one or more actions should be performed in response to detecting that the user logged into the website using the second browser, where the one or more actions are configured to protect the content element.

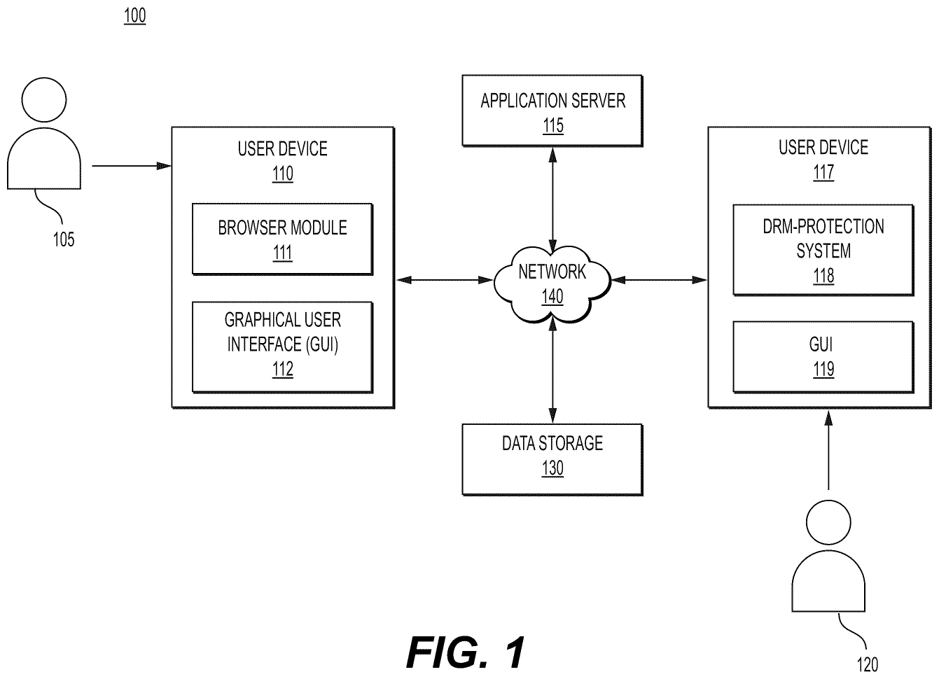

FIG. 1 depicts an exemplary environment 100 for dynamically generating DRM protections, according to one or more embodiments. In some aspects, the environment 100 may be an embodiment of (i) environment 100 described in U.S. Provisional Application 63/587,891, filed on Oct. 4, 2023, (ii) environment 100 described in U.S. Provisional Application 63/665,485, filed Jun. 28, 2024, or (iii) environment 100 described in U.S. Provisional Application 63/683,063, filed Aug. 14, 2024, where each of these U.S. provisional applications is incorporated by reference herein in its entirety. Environment 100 may include one or more aspects that may communicate with each other over a network 140, including, e.g., at least one memory storing instructions, and at least one processor operatively connected to the at least one memory and configured to execute the instructions to perform operations for dynamically generating DRM protections on a case-by-case basis.

In some embodiments, a user 105 may interact with a user device 110 such that media content (e.g., a browser, a website, a webpage, etc.) including at least one content element may be loaded. As discussed herein, the at least one content element may be associated with sensitive information. As depicted in FIG. 1, a user 105 may be an individual authorized to use, access, etc. user device 110 or access, view, etc. the sensitive information discussed herein. User device 110 may interact with at least one of an application server 115, a user device 117, a data storage 130, etc. User device 110 may be configured to enable user 105 to access or interact with other systems in environment 100.

In some embodiments, a user 120 may interact with a user device 117 such that information associated with digital extraction may be managed. A user 120 may be an individual associated with a third party, such as a third party facilitating, monitoring, etc. the DRM protections discussed herein. User device 117 may be configured to enable user 120 to access or interact with other systems in environment 100.

In some embodiments, user devices 110, 117 may be a computer system, e.g., a desktop computer, a laptop computer, a tablet, a smart cellular phone, a smart watch or other electronic wearable, etc. In some embodiments, user devices 110, 117 may include one or more electronic applications, e.g., a program, plugin, browser extension, etc., installed on a memory of user device 110, 117. In some embodiments, the electronic applications may be associated with one or more of the other components in the environment 100.

User device 110 may include a browser module 111 or a graphical user interface (“GUI”) 112. User device 110—or the one or more aspects of user device 110, e.g., browser module 111, GUI 112, etc.—may be configured to obtain data from one or more aspects of environment 100. For example, user device 110 may be configured to receive data from browser module 111, GUI 112 (e.g., via one or more inputs from user 105), application server 115, user device 117, DRM-protection system 118, GUI 119 (e.g., via one or more inputs from user 120), data storage 130, etc. User device 110 may be configured to transmit data to one or more aspects of environment 100, e.g., to browser module 111, GUI 112 (e.g., via one or more inputs from user 105), application server 115, user device 117, DRM-protection system 118, GUI 119 (e.g., via one or more inputs from user 120), data storage 130, etc.

Browser module 111 may be configured to detect loading of media content, a content element, etc. For example, user 105 may operate user device 110 to load media content (e.g., a website). Browser module 111 may be configured to detect or receive an indication of the request for media content to be loaded. In some embodiments, browser module 111 may be configured to detect or receive the request for at least one content element (e.g., a first content element, a second content element, a third content element, etc.) associated with media content to be loaded.

Browser module 111 may be configured to detect, analyze, or transmit (e.g., to application server 115) an indication of digital extraction (e.g., screensharing, screenshotting, screen capture, etc.). In some embodiments, browser module 111 may be configured to receive the indication of digital extraction from other aspects of environment 100, such as user device 110, application server 115, data storage 130, etc. In some embodiments, browser module 111 may be configured to detect digital extraction based on indirect measures of digital extraction. Indirect measures of digital extraction may include historical user behavior (e.g., mouse movements by the user), interaction patterns (e.g., a comparison of how the user has historically interacted with a webpage and how the user is now interacting with the webpage), screen resolution changes, user input(s), etc. For example, browser module 111 may be configured to detect user input(s) that may be indicative of screenshotting, such as simultaneously pressing and releasing the lock button and the volume up button on a user device (e.g., user device 105). In some embodiments, browser module 111 may be configured to infer or predict digital extraction may be occurring. For example, browser module 111 may be configured to determine a screensharing application, such as Zoom®, may be operating on a user device (e.g., user device 110) while a user (e.g., user 105) is accessing sensitive information. Browser module 111 may be configured to determine the indication of digital extraction based on the simultaneous operation of the screensharing application and the accessing sensitive information on user device 110.

Browser module 111 may be configured to determine whether sensitive information is being accessed via digital extraction. In some embodiments, browser module 111 may be configured to determine whether sensitive information is being accessed via a first media content (e.g., a first website), a second media content (e.g., a second website), etc. For example, browser module 111 may be configured to determine whether first sensitive information is being accessed via one or both of a first media content or a second media content. In another example, browser module 111 may be configured to determine whether first sensitive information is being accessed via a first media content (e.g., a first webpage associated with DRM protection), then (e.g., subsequently) via a second media content (e.g., a second webpage that is not associated with DRM protection).

In some embodiments, browser module 111 may be configured to determine whether digital extraction is associated with a first media content, a second media content, etc. For example, browser module 111 may be configured to determine a first indication of digital extraction is associated with a first media content (e.g., a DRM-protected media content), and a second indication of digital extraction is associated with a second media content (e.g., a non-DRM-protected media content).

Browser module 111 may be configured to receive data from other aspects of environment 100, such as from user device 110, GUI 112 (e.g., via one or more inputs from user 105), application server 115, user device 117, DRM-protection system 118, GUI 119 (e.g., via one or more inputs from user 120), data storage 130, etc. Browser module 111 may be configured to transmit the indication of digital extraction, e.g., to other aspects of environment 100, such as to user device 110, GUI 112 (e.g., via one or more inputs from user 105), application server 115, user device 117, DRM-protection system 118, GUI 119 (e.g., via one or more inputs from user 120), data storage 130, etc. For example, browser module 111 may be configured to transmit the determination of whether sensitive information is being accessed or whether digital extraction is occurring in association with a media content (e.g., a first media content, a second media content, etc.) to other aspects of environment 100.

GUI 112 may be configured to output media, DRM-protected media, alert(s), etc. GUI 112 may be configured to output any number or any combination of media (e.g., first media, second media, third media, etc.), DRM-protect media (e.g., first DRM-protect media, second DRM-protect media, third DRM-protect media, etc.), alert(s) (e.g., a first alert, a second alert, etc.), etc.

GUI 112 may be configured to receive data for output (e.g., media, DRM-protected media, alert(s), etc.) from other aspects of environment 100, such as from user device 110, browser module 111, application server 115, user device 117, DRM-protection system 118, GUI 119 (e.g., via one or more inputs from user 120), data storage 130, etc. GUI 112 may be configured to transmit data (e.g., at least one user input) to other aspects of environment 100, such as to user device 110, browser module 111, application server 115, user device 117, DRM-protection system 118, GUI 119 (e.g., via one or more inputs from user 120), data storage 130, etc.

Application server 115 may be configured to determine an identity of an application associated with the indication of digital extraction (hereinafter the “identity”). The identity may include the application facilitating the digital extraction, for example QuickTime®, Zoom®, applications built into a device, etc.). For example, if a user (e.g., user 105) is screensharing (e.g., screensharing via GUI 112) with a social engineer via Zoom®, application server 115 may be configured to determine the identity is “Zoom®.” In another example, if a user (e.g., user 105) is screensharing (e.g., screensharing GUI 112) with a social engineer via Zoom® and the social engineer takes a screenshot via a built-in screenshot application, application server 115 may be configured to determine the identity is one or both of “built-in screenshot application” or “Zoom®.” Application server 115 may be configured to transmit the identity to other aspects of environment 100, as discussed herein.

Application server 115 may be configured to determine a mode associated with the indication of digital extraction (hereinafter the “mode”). The mode may include the method by which digital extraction may be occurring or have occurred, for example, screensharing, screenshotting, screen capturing, etc. For example, if a user (e.g., user 105) is screensharing (e.g., screensharing GUI 112) with a social engineer via Zoom®, application server 115 may be configured to determine the mode is “screensharing.” In another example, if a user (e.g., user 105) is screensharing (e.g., screensharing GUI 112) with a social engineer via Zoom® and the social engineer takes a screenshot via a built-in screenshot application, application server 115 may be configured to determine the mode is one or both of “screenshot” or “screensharing.” Application server 115 may be configured to transmit the mode to other aspects of environment 100, as discussed herein.

Application server 115 may be configured to tag the indication of digital extraction based on one or both of the identity or the mode. For example, application server 115 may be configured to tag the indication of digital extraction to indicate one or both of the identity or the mode. Application server 115 may be configured to transmit the tagged indication of digital extraction to other aspects of environment 100, as discussed herein. In some embodiments, application server 115 may be configured to tag the indication of digital extraction by including a natural language message, such as a natural language message of one or both of the identity or the mode. For example, if digital extraction is indicated based on use of Zoom®, the indication of digital extraction may be tagged with the natural language message “Zoom®.”

Application server 115 may be configured to generate at least one alert. In some embodiments, application server 115 may be configured to generate the at least one alert based on at least one of the indication of digital extraction, the tagged indication of digital extraction, the determined identity of the application, or the determined mode of the digital extraction. In some embodiments, application server 115 may be configured to generate the at least one alert based on the intended recipient individual (e.g., user 105, user 120, etc.). The at least one alert may include any suitable information, such as a message (e.g., a message to user 105, a message to user 120, etc.), the identity, the mode, etc. For example, application server 115 may be configured to generate a first alert for user 120. The first alert may include a message for user 120, for example, “Customer A's information is compromised via Zoom® screensharing,” etc. In another example, application server 115 may be configured to generate a second alert for user 105. The second alert may include a message for user 105, for example, “You're information is being shared,” etc. Application server 115 may be configured to transmit the at least one alert to other aspects of environment 100, as discussed herein. In an example, where the content element represents a checking account number, application server 115 may be configured to determine that a checking account associated with the checking account number should be locked (or frozen) as a precautionary measure (e.g., in case the user screenshares the display screen, or a social engineer takes a screenshot of the display screen when using the second browser to view the content element).

Application server 115 may be configured to generate media, e.g., media associated with sensitive information. The media may be a single frame-looped video. The media may be one (1) pixel by one (1) pixel. The media may be substantially transparent. For example, the media may be about 70%-80%, about 80%-90%, about 90%-99%, etc. transparent. It may be advantageous for the media to be less than 100% transparent because the DRM protection techniques may fail to completely render media that is 100% transparent, and therefore may fail to effectively block the 100% transparent media. In some embodiments, application server 115 maybe configured to generate media in response to the loading indication of media content, a content element, etc., the indication of digital extraction, etc. For example, application server 115 may generate media in response to receiving at least one of the loading indication of media content, a content element, etc. or the indication of digital extraction (e.g., from browser module 111).

Application server 115 may be configured to modify the DRM-protected content element (e.g., first DRM-protected content element, second DRM-protected content element, third DRM-protected content element, etc.) to generate a modified DRM-protected content element. The DRM-protected content element may be modified based on the format of the DRM-protected content element, e.g., from substantially transparent to substantially opaque, from a video to an image, from a single frame-looped video to an image, etc. For example, application server 115 may be configured to convert a substantially transparent DRM-protected media (e.g., a substantially transparent single frame-looped video) to substantially opaque modified DRM-protected media (e.g., a substantially opaque single frame-looped video). In another example, application server 115 may be configured to convert a looped-video DRM-protected media (e.g., a single frame-looped video) to an image to generate a modified DRM-protected media (e.g., a paused single frame-looped video). Application server 115 may be configured to transmit the modified DRM-protected content element to other aspects of environment 100, as discussed herein.

Application server 115 maybe configured to obtain data from one or more aspects of environment 100. For example, application server 115 may be configured to receive data from user device 110, browser module 111, GUI 112 (e.g., via one or more inputs from user 105), user device 117, DRM-protection system 118, GUI 119 (e.g., via one or more inputs from user 120), data storage 130, etc. Application server 115 may be configured to transmit data to one or more aspects of environment 100, e.g., to user device 110, browser module 111, GUI 112 (e.g., via one or more inputs from user 105), user device 117, DRM-protection system 118, GUI 119 (e.g., via one or more inputs from user 120), data storage 130, etc. For example, application server 115 may be configured to transmit a first alert to DRM-protection system 118 (e.g., to be caused to be output via GUI 119) and a second alert to user device 110 (e.g., to be caused to be output via GUI 112).

User device 117 may be configured to enable user 120 to access or interact with other systems in the environment 100. User device 117 may include a digital rights management (“DRM”)-protection system 118 or a GUI 119. User device 117—or the one or more aspects of user device 117, e.g., DRM-protection system 118, GUI 119, etc.—may be configured to obtain data from one or more aspects of environment 100. For example, user device 117 may be configured to receive data from user device 110, browser module 111, GUI 112 (e.g., via one or more inputs from user 105), application server 115, DRM-protection system 118, GUI 119 (e.g., via one or more inputs from user 120), data storage 130, etc. User device 117 may be configured to transmit data to one or more aspects of environment 100, e.g., to user device 110, browser module 111, GUI 112 (e.g., via one or more inputs from user 105), application server 115, DRM-protection system 118, GUI 119 (e.g., via one or more inputs from user 120), data storage 130, etc.

DRM-protection system 118 may be configured to implement at least one protective action. The at least one protective action may be configured to protect (or safeguard) a content element, sensitive information, etc. The at least one protective action may include at least one of pausing, locking, canceling, etc. an account (e.g., a financial account) associated with the sensitive information, transmitting the at least one alert (e.g., to GUI 112), etc. In some embodiments, DRM-protection system 118 may be configured to implement the at least one protective action based on at least one of the indication of digital extraction, the tagged indication of digital extraction, the identity, the mode, the at least one alert (e.g., the first alert, the second alert, etc.), etc. For example, where the content element represents a checking account number, DRM-protection system 118 may be configured to lock (or freeze) the checking account associated with the checking account number as a precautionary measure.

DRM-protection system 118 maybe configured to obtain data from one or more aspects of environment 100. For example, DRM-protection system 118 may be configured to receive data from user device 110, browser module 111, GUI 112 (e.g., via one or more inputs from user 105), application server 115, user device 117, GUI 119 (e.g., via one or more inputs from user 120), data storage 130, etc. DRM-protection system 118 may be configured to transmit data to one or more aspects of environment 100, e.g., to user device 110, browser module 111, GUI 112 (e.g., via one or more inputs from user 105), application server 115, user device 117, GUI 119 (e.g., via one or more inputs from user 120), data storage 130, etc.

GUI 119 may be configured to output alert(s), etc. For example, GUI 119 may be configured to output a second alert. User 120 may interact with the second alert via GUI 119. GUI 119 may be configured to output any number or any combination of media (e.g., first media, second media, third media, etc.), DRM-protect media (e.g., first DRM-protect media, second DRM-protect media, third DRM-protect media, etc.), alert(s) (e.g., a first alert, a second alert, etc.), etc.

GUI 119 may be configured to receive data for outputting (e.g., media, DRM-protected media, alert(s), etc.) from other aspects of environment 100, such as from user device 110, browser module 111, GUI 112 (e.g., via one or more inputs from user 105), application server 115, user device 117, DRM-protection system 118, data storage 130, etc. GUI 119 may be configured to transmit data (e.g., at least one user input) to other aspects of environment 100, such as to user device 110, browser module 111, GUI 112 (e.g., via one or more inputs from user 105), application server 115, user device 117, DRM-protection system 118, data storage 130, etc.

Data storage 130 may be configured to cache media (e.g., first media, second media, etc.), DRM-protected media (e.g., first DRM-protected media, second DRM-protected media, etc.), etc. Data storage 130 may be configured to receive for caching, receive for storage, store, retrieve from the storage, or transmit from the storage: media (e.g., first media, second media, etc.), DRM-protected media (e.g., first DRM-protected media, second DRM-protected media, etc.), alert(s) (e.g., the first alert, the second alert, etc.), etc. Data storage 130 may be configured to receive data from other aspects of environment 100, such as from user device 110, browser module 111, GUI 112 (e.g., via one or more inputs from user 105), application server 115, user device 117, DRM-protection system 118, GUI 119 (e.g., via one or more inputs from user 120), etc. Data storage 130 may be configured to transmit data to other aspects of environment 100, such as to user device 110, browser module 111, GUI 112 (e.g., via one or more inputs from user 105), application server 115, user device 117, DRM-protection system 118, GUI 119 (e.g., via one or more inputs from user 120), etc.

One or more of the components in FIG. 1 may communicate with each other or other systems, e.g., across network 140. In some embodiments, network 140 may connect one or more components of environment 100 via a wired connection, e.g., a USB connection between user device 110 and data storage 130. In some embodiments, network 140 may connect one or more aspects of environment 100 via an electronic network connection, for example a wide area network (WAN), a local area network (LAN), personal area network (PAN), a content delivery network (CDN), or the like. In some embodiments, the electronic network connection includes the internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network may obtain information from any other computer and communicate with parties of other computers or devices. The most widely used part of the Internet is the World Wide Web (often-abbreviated “WWW” or called “the Web”). A “website page,” a “portal,” or the like generally encompasses a location, data store, or the like that is, for example, hosted or operated by a computer system so as to be accessible online, and that may include data configured to cause a program such as a web browser to perform operations such as send, receive, or process data, generate a visual display or an interactive interface, or the like. In any case, the connections within the environment 100 may be network, wired, any other suitable connection, or any combination thereof.

Although depicted as separate components in FIG. 1, it should be understood that a component or portion of a component in the environment 100 may, in some embodiments, be integrated with or incorporated into one or more other components. For example, browser module 111 may be integrated in application server 115. In some embodiments, operations or aspects of one or more of the components discussed above may be distributed amongst one or more other components, e.g., one or both of browser module 111 or application server 115.

In some embodiments, some of the components of environment 100 may be associated with a common entity, while others may be associated with a disparate entity. For example, browser module 111 and application server 115 may be associated with a common entity (e.g., an entity with which user 105 has an account) while data storage 130 may be associated with a third party (e.g., a provider of data storage services). Any suitable arrangement or integration of the various systems and devices of the environment 100 may be used.

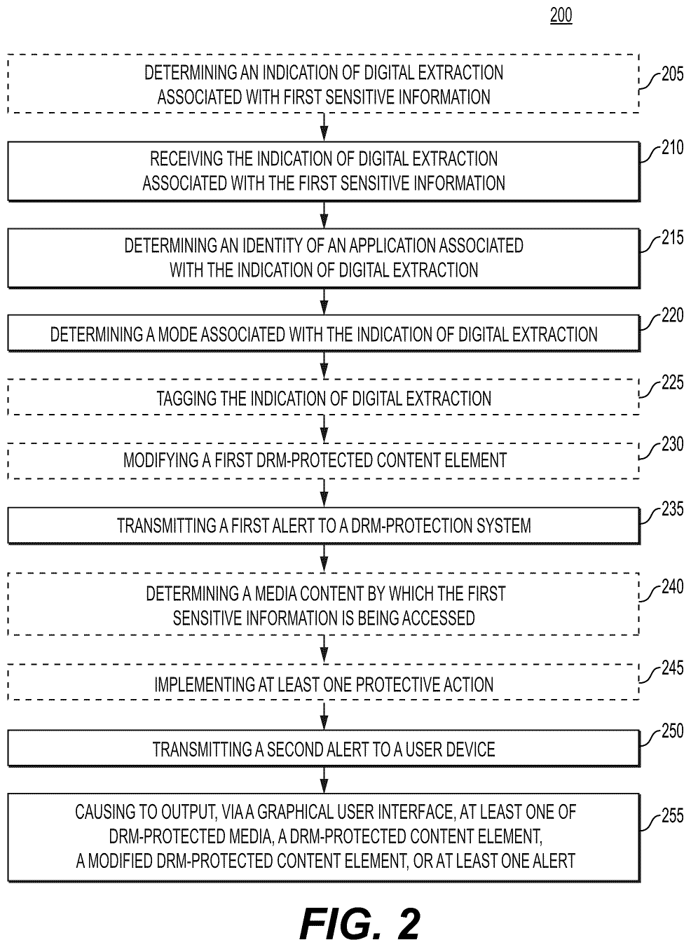

FIG. 2 depicts an exemplary method 200 for dynamically generating DRM protections, according to one or more embodiments. Aspects of the present disclosure relate to systems and methods for protecting one or more content elements displayed on a webpage of a website, e.g., by dynamically generating DRM protections on a case-by-case basis. For example, a system may comprise at least one memory storing instructions, and at least one processor operatively connected to the at least one memory and configured to execute the instructions to perform operations for protecting a content element, e.g., by dynamically generating DRM protections.

Prior to initiation of method 200, in some embodiments, a DRM-protected content element and DRM-protected media may be generated and caused to be output via a GUI (e.g., GUI 112). The operations may include generating (e.g., via application server 115) a first DRM-protected media associated with the first content element. In some embodiments, the first DRM-protected media may be generated in response to receipt of (e.g., via application server 115 or browser module 111) a request to load (or display) the first media content (e.g., a first webpage of the first website) on a display screen of a first computing device (e.g., GUI 112). The first content element may be associated with the first media content. Further, in some aspects, the first DRM-protected media may include or be associated with one or more DRM technologies that have protected the first media, and thus the first DRM-protected media may be DRM-protected. In some aspects, the DRM technologies may restrict the first DRM-protected media from being shared or recorded (or captured) using at least one screen sharing application, remote desktop application, or screenshotting application. In some embodiments, the operations may further include forming (e.g., via browser module 111 or application server 115) a second DRM-protected content element including the first DRM-protected media. For example, the first DRM-protected media may be utilized for more than one DRM-protected content element (e.g., for the first DRM-protected content element and the second DRM-protected content element). Further, in some embodiments, the first DRM-protected content element may include a second HTML element generated to include the first DRM-protected media. For example, a first HTML element of a first content element may be modified (e.g., encrypted) to generate a second HTML element. In other words, the second HTML element may include the first HTML element modified to include DRM protections.

The operations may further include outputting (e.g., via browser module 111) the first DRM-protected media of the second HTML element and the DRM-protected content element to the display screen (e.g., via GUI 112). In some aspects, the first DRM-protected media of the second HTML element may be displayed on top of the content element (e.g., overlaid on top of the content element). In some embodiments, where the display screen is not being electronically shared or recorded (or captured), the first DRM-protected media may be played and appear as a transparent or substantially transparent region on the display screen (e.g., GUI 112) during the playing so that a person who views the display screen (e.g., user 105) can view the content element presented under the first DRM-protected media. Conversely, where the display screen (e.g., GUI 112) is being electronically shared or recorded, the DRM technologies (or protections) of the first DRM-protected media may cause the first DRM-protected media to stop playing (or not play), and while the first DRM-protected media is not played, the first DRM-protected media may appear as an opaque or substantially opaque region that conceals the content element presented under the first DRM-protected media. As a result, the first DRM- protected media may protect the content element (and associated sensitive information) from being digitally extracted or captured by a social engineer.

Optionally, at step 205, an indication of digital extraction associated with first sensitive information may be determined. The indication of digital extraction may be any indication that a display screen (e.g., GUI 112) is being or has been screenshared, screenshot, screen captured, etc. For example, the operations may include detecting (e.g., via browser module 111) that the display screen (e.g., GUI 112) is being shared using an application operating on the computing device (e.g., user device 110) (and that the first video has thus stopped playing). The indication of digital extraction may include information relating to the sensitive information, content element, etc. being shared. For example, sensitive information relating to an individual's (e.g., user 105) password may be associated with the indication of digital extraction.

In some embodiments, the indication of digital extraction may be determined based on at least one indirect factor, such as user inputs, enabled settings, concurrently operating applications, etc., as discussed in more detail above. For example, if a user input that may be indicative of screenshotting is detected, such as Zoom® operating on a user device (e.g., on user device 110) while a user (e.g., user 105) is accessing sensitive information, digital extraction may be indicated.

In some embodiments, the indication of digital extraction may be determined based on receipt of an indication that the first DRM-protected content element or the first DRM-protected media are modified. For example, if the first DRM-protected content element or the first DRM-protected media are modified such that the sensitive information is made not visible (e.g., via GUI 112), the modification may represent that digital extraction may have or may be occurring; an indication of digital extraction may be determined therefrom.

At step 210, the indication of digital extraction associated with the first sensitive information may be received, e.g., via application server 115. The indication of digital extraction associated with the first sensitive information may be transmitted, e.g., by browser module 111 to application server 115. In some embodiments, one or both of the indication of digital extraction or the indication of modification of the first DRM-protected content element or the first DRM-protected media may be received (e.g., via application server 115).

At step 215, an identity of an application associated with the indication of digital extraction (hereinafter the “identity”) may be determined. For example, the operations may include determining (e.g., via application server 115) an identity of the application being used to share the display screen. As discussed herein, the identity may be include the application facilitating the digital extraction, for example QuickTime®, Zoom®, applications built into a device, etc. For example, if a user (e.g., user 105) is screensharing (e.g., screensharing GUI 112) with a social engineer via Zoom®, the identity may be determined (e.g., via application server 115) to be “Zoom®.” In another example, if a user (e.g., user 105) is screensharing (e.g., screensharing GUI 112) with a social engineer via Zoom® and the social engineer takes a screenshot via a built-in screenshot application, the identity may be determined (e.g., via application server 115) to be one or both of “built-in screenshot application” or “Zoom®.”

At step 220, a mode associated with the indication of digital extraction may be determined. In some embodiments, the mode may be determined based on the identity. As discussed herein, the mode may include the method by which digital extraction may be occurring or have occurred, for example, screensharing, screenshotting, screen capturing, etc. For example, if a user (e.g., user 105) is screensharing (e.g., screensharing GUI 112) with a social engineer via Zoom®, the mode may be determined (e.g., via application server 115) to be “screensharing.” In another example, if a user (e.g., user 105) is screensharing (e.g., screensharing GUI 112) with a social engineer via Zoom® and the social engineer takes a screenshot via a built-in screenshot application, the mode may be determined (e.g., via application server 115) to be one or both of “screenshot” or “screensharing.”

Optionally, at step 225, the indication of digital extraction may be tagged (e.g., via application server 115). In some embodiments, the indication of digital extraction may be tagged based on the identity, the mode, etc. For example, the indication of digital extraction may be tagged to indicate one or both of the identity or the mode. Tagging the indication of digital extraction may include a natural language message, such as a natural language message of one or both of the identity or the mode.

Optionally, at step 230, the first DRM-protected content element may be modified to generate a modified DRM-protected content element. In some embodiments, the first DRM-protected content element may be modified in response to receipt (e.g., via browser module 111, application server 115, etc.) of the indication of digital extraction. In some embodiments, modifying the first DRM-protected content element may include modifying the DRM-protected media associated with the DRM-protected content element.

The DRM-protected content element (or DRM-protected media) may be modified based on the identity, the mode, or the format of the DRM-protected media, e.g., from substantially transparent to substantially opaque, from a video to an image, from a single frame-looped video to an image, etc. For example, a substantially transparent DRM-protected media (e.g., a substantially transparent single frame-looped video) may be modified to a substantially opaque modified DRM-protected media (e.g., a substantially opaque single frame-looped video). In another example, a looped-video DRM-protected media (e.g., a single frame-looped video) may be modified to a paused video to generate a modified DRM-protected media (e.g., a paused single frame-looped video). In a further example, a looped-video DRM-protected media (e.g., a single frame-looped video) may be modified to an image to generate a modified DRM-protected media (e.g., an image).

At step 235, a first alert may be transmitted to a DRM-protection system (e.g., to DRM-protection system 118). For example, the operations may include transmitting (e.g., via browser module 111 or application server 115) a message (e.g., a first alert) indicating the identity, the mode, the indication of digital extraction, or a tagged indication of digital extraction; and receiving (e.g., via DRM-protection system 118) the message (e.g., a first alert).

In some embodiments, the first alert may be generated (e.g., via application server 115) based on at least one of the identity, the mode, the indication of digital extraction, or a tagged indication of digital extraction. For example, if the identity is “Zoom®,” the mode is “screenshot,” and the indication of digital extraction is tagged based on the sensitive information being “social security number,” the first alert may be generated therefrom. In some embodiments, the first alert may be generated to include any suitable information and in any suitable format. For example, the first alert may be generated to include a message (e.g., natural language text, etc.) directed to the relevant individual (e.g., user 120). An example of a natural language message may include “Customer A's sensitive information has been compromised via QuickTime® screenshotting.”

Optionally, at step 240, the media content (e.g., browser, website, etc.) by which the first sensitive information is being accessed may be determined (e.g., via browser module 111). In some embodiments, determining the media content(s) by which the first sensitive information is being accessed may include determining whether digital extraction is associated with more than one media content, or the order in which digital extraction is associated with more than one media content. For example, if a user (e.g., user 105) is screensharing with a social engineer, DRM-protected media may be caused to be output (e.g., via GUI 112) using a first media content (e.g., a browser associated with DRM protection The social engineer may direct the user (e.g., user 105) to access a second media content (e.g., a browser not associated with DRM protection). It may be determined that the indication of digital extraction is associated with both the first media content and the second media content, or that the indication of digital extraction is associated with the first media content then the second media content.

In some embodiments, the operations may include detecting (e.g., via browser module 111, application server 115, etc.) that a user (e.g., user 105) has logged into a website using a first browser (e.g., first media content) on a computing device (e.g., user device 110). In some aspects, the first browser may be configured to support DRM technologies (e.g., to protect the content element from being transmitted to a social engineer via screensharing or screenshotting). Further, the user may be associated with an account that is accessible via the website.

In some embodiments, the operations may include detecting (e.g., via browser module 111, application server 115, etc.) that the user (e.g., user 105) has logged into the website using a second browser (e.g., second media content) on a computing device (e.g., user device 110). In some aspects, the second browser may not be configured to support DRM technologies. The detection that the user (e.g., user 105) has logged into the website using a second browser on the computing device may be subsequent to the user logging into the website using the first browser. The determined media content(s) by which the first sensitive information is being accessed may be transmitted, e.g., to browser module 111, application server 115, etc.

Optionally, at step 245, at least one protective action may be implemented. In some embodiments, the at least one protective action may be implemented (e.g., via DRM-protection system 118) based on at least one of the indication of digital extraction, the tagged indication of digital extraction, the identity, the mode, the at least one alert (e.g., the first alert, the second alert, etc.), etc. As discussed herein, the at least one protective action may be configured to protect (or safeguard) a content element, sensitive information, etc. The at least one protective action may include at least one of pausing, locking, canceling, etc. a financial account associated with the sensitive information, transmitting the at least one alert (e.g., to GUI 112), etc. For example, where the sensitive information includes a social security number, the at least one protective action may include at least one of alerting the individual associated with the social security number (e.g., user 105), requesting permission to notify or notifying at least one credit bureau (e.g., Equifax®, Experian®, or TransUnion®), causing the user (e.g., user 105) to log out of the application, etc.

In some embodiments, the operations may include logging (or recording) a first alert, and determining whether one or more actions associated with the identity of the content element (associated with the first alert) should be performed. For example, where the content element (or identity of the content element) represents a credit card number, the at least one protective action may include locking (or freezing) the account associated with the credit card number as a precautionary measure (e.g., in case the DRM technologies failed to conceal the content element during the screensharing).

In some embodiments, based on the determined media content by which the first sensitive information is being accessed (see step 240), the operations may further include determining whether the at least one protective action should be performed in response to detecting that a user (e.g., user 105) logged into a website including sensitive information using a second browser. For example, if it is detected that the user logged in using a second browser (e.g., a non-DRM-protected media content), at least one protective action may be implemented. In another example, if it is detected that the user logged in using a first browser (e.g., a DRM-protected media content) and subsequently logged in using a second browser (e.g., a non-DRM-protected media content), at least one protective action may be implemented.

Optionally, at step 250, a second alert may be transmitted (e.g., to user device 110). For example, the second alert may be an alert directed to an individual (e.g., user 105) associated with sensitive information or user device 110. In some embodiments, the second alert may be generated to include any suitable information and in any suitable format (e.g., a message including natural language text, etc.). In some embodiments, the second alert may be generated (e.g., via application server 115) based on at least one of the identity, the mode, the indication of digital extraction, or a tagged indication of digital extraction. For example, if the identity is “Zoom®,” the mode is “screenshot,” and the indication of digital extraction is tagged based on the sensitive information being “social security number,” the second alert may be generated to include the natural language message: “Your sensitive information, including your social security number, has been compromised via Zoom® screenshotting.”

At step 255, at least one of the modified first DRM-protected media, the modified first DRM-protected content element, the first alert, or the second alert may be caused to be caused to be output via at least one GUI (e.g., GUI 112, GUI 119, etc.). In some embodiments, the modified first DRM-protected media or the modified first DRM-protected content element may be caused to be output such that the modified first DRM-protected media (e.g., the modified DRM-protected media) may be caused to be displayed (e.g., via GUI 112). For example, the modified first DRM-protected media may be substantially opaque, such that sensitive information may not be visible (e.g., via GUI 112).

In some embodiments, the first alert may be associated with a third party, such as with an individual (e.g., user 120) or entity facilitating the DRM protections. As such, the first alert may be caused to be output via a device associated with the individual or entity facilitating the DRM protections (e.g., via GUI 119). In some embodiments, the second alert may be associated with an individual, such as the individual associated with the sensitive information (e.g., user 105). As such, the second alert may be caused to be output via a device associated with the individual (e.g., via GUI 112).

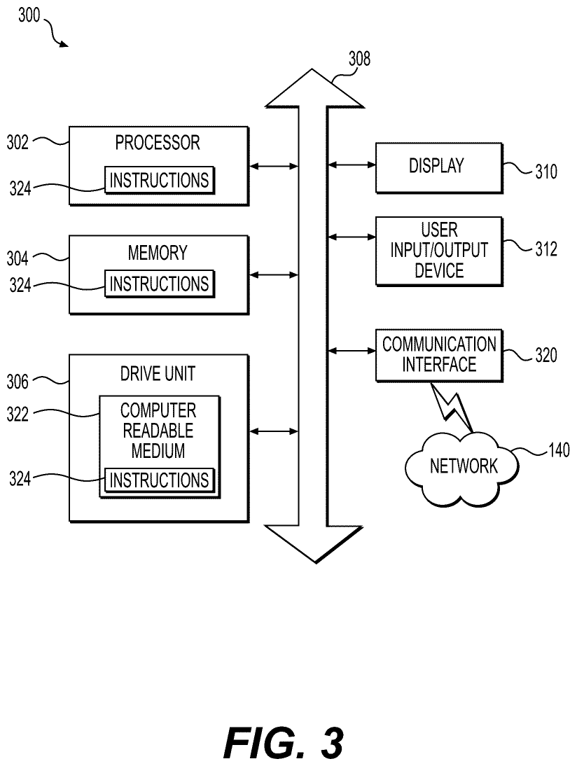

FIG. 3 depicts a simplified functional block diagram of a computer 300 that may be configured as a device for executing the methods disclosed here, according to exemplary embodiments of the present disclosure. For example, the computer 300 may be configured as a system according to exemplary embodiments of this disclosure. In various embodiments, any of the systems herein may be a computer 300 including, for example, a data communication interface 320 for packet data communication. The computer 300 also may include a central processing unit (CPU) 302, in the form of one or more processors, for executing program instructions. The computer 300 may include an internal communication bus 308, and a storage unit 306 (such as ROM, HDD, SDD, etc.) that may store data on a computer readable medium 322, although the computer 300 may receive programming and data via network communications. The computer 300 may also have a memory 304 (such as RAM) storing instructions 324 for executing techniques presented herein, although the instructions 324 may be stored temporarily or permanently within other modules of computer 300 (e.g., processor 302 or computer readable medium 322). The computer 300 also may include input and output ports 312 or a display 310 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention. The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for dynamically generating digital rights management (“DRM”) protections, the method comprising:
receiving, via an application server, an indication of digital extraction associated with first sensitive information, wherein the first sensitive information and a first DRM-protected media having been caused to be displayed via a graphical user interface (“GUI”) and each are associated with a first DRM-protected content element;
determining, via an application server, an identity of an application associated with the indication of digital extraction;
determining, via an application server, a mode associated with the indication of digital extraction, wherein the mode includes at least one of screensharing, screen shotting, or screen capture; and
based on the determined identity of the application and the determined mode of the digital extraction, transmitting a first alert to a DRM-protection system.

2. The method of claim 1, wherein receiving the indication of digital extraction associated with first sensitive information further comprises:
receiving, via the application server, an indication that the first DRM-protected media was modified.

3. The method of claim 2, further comprising:
determining, via a browser module, the indication of digital extraction based on at least one of the indication that the first DRM-protected media was modified or the identity of the application associated with the indication of digital extraction.

4. The method of claim 1, wherein determining the mode of digital extraction is based on the identity of the application associated with the digital extraction.

5. The method of claim 1, further comprising:
based on the determined mode of digital extraction, modifying the first DRM-protected content element such that the first DRM-protected media is made substantially opaque or stops playing via the application server; and
causing to output, via the GUI, the modified first DRM-protected media.

6. The method of claim 1, further comprising:
receiving the first alert via a DRM-protection system; and
based on the first alert, implementing at least one protective action via the DRM- protection system.

7. The method of claim 1, further comprising:
based on the determined identity of the application and the determined mode of the digital extraction, transmitting a second alert to a user device; and
causing to output, via the user device, the second alert.

8. The method of claim 1, further comprising:
determining whether the first sensitive information is being accessed via a first media content or a second media content, wherein the first media content is associated with DRM protections and the second media content is not associated with DRM protections; and
upon determining the first sensitive information is being accessed via a second media content, transmitting at least one of the first alert to the DRM-protection system or a second alert to a user device.

9. The method of claim 1, further comprising:
based on the determined identity of the application and the determined mode of the digital extraction, tagging the indication of digital extraction.

10. A system, the system comprising:
at least one memory storing instructions; and
at least one processor operatively connected to the memory, and configured to execute the instructions to perform operations for dynamically generating digital rights management (“DRM”) protections, the operations including:
receiving, via an application server, an indication of digital extraction associated with first sensitive information, wherein the first sensitive information and a first DRM-protected media having been caused to be displayed via a graphical user interface (“GUI”) and each are associated with a first DRM-protected content element;
determining, via an application server, an identity of an application associated with the indication of digital extraction;
determining, via an application server, a mode associated with the indication of digital extraction, wherein the mode includes at least one of screensharing, screen shotting, or screen capture; and
based on the determined identity of the application and the determined mode of the digital extraction, transmitting a first alert to a DRM-protection system.

11. The system of claim 10, wherein receiving the indication of digital extraction associated with first sensitive information further comprises:
receiving, via the application server, an indication that the first DRM-protected media was modified.

12. The system of claim 11, wherein the operations further include:
determining, via a browser module, the indication of digital extraction based on at least one of the indication that the first DRM-protected media was modified or the identity of the application associated with the indication of digital extraction.

13. The system of claim 10, wherein determining the mode of digital extraction is based on the identity of the application associated with the digital extraction.

14. The system of claim 10, wherein the operations further include:
based on the determined mode of digital extraction, modifying the first DRM-protected content element such that the first DRM-protected media is made substantially opaque or stops playing via the application server; and
causing to output, via the GUI, the modified first DRM-protected media.

15. The system of claim 10, wherein the operations further include:
receiving the first alert via a DRM-protection system; and
based on the first alert, implementing at least one protective action via the DRM-protection system.

16. The system of claim 10, wherein the operations further include:
based on the determined identity of the application and the determined mode of the digital extraction, transmitting a second alert to a user device; and
causing to output, via the user device, the second alert.

17. The system of claim 10, wherein the operations further include:
determining whether the first sensitive information is being accessed via a first media content or a second media content, wherein the first media content is associated with DRM protections and the second media content is not associated with DRM protections; and
upon determining the first sensitive information is being accessed via a second media content, transmitting at least one of the first alert to the DRM-protection system or a second alert to a user device.

18. The system of claim 10, wherein the operations further include:
based on the determined identity of the application and the determined mode of the digital extraction, tagging the indication of digital extraction.

19. A method for dynamically generating digital rights management (“DRM”) protections, the method comprising:
receiving, via an application server, an indication of digital extraction associated with first sensitive information, wherein the first sensitive information and a first DRM-protected media having been caused to be displayed via a graphical user interface (“GUI”) are associated with a first DRM-protected content element;
determining, via an application server, an identity of an application associated with the indication of digital extraction;
determining, via an application server, a mode associated with the indication of digital extraction, wherein the mode of digital extraction includes at least one of screensharing, screen shotting, or screen capture;
based on the determined mode of digital extraction, modifying the first DRM-protected content element such that the first DRM-protected media is made substantially opaque or stops playing via the application server;
based on the determined identity of the application and the determined mode of the digital extraction, transmitting a first alert to a DRM-protection system and a second alert to a user device;
based on the first alert, implementing at least one protective action via the DRM-protection system; and
causing to output, via a GUI associated with the user device, the modified first DRM-protected media and the second alert.

20. The method of claim 19, further comprising:
determining whether the first sensitive information is being accessed via a first media content or a second media content, wherein the first media content is associated with DRM protections and the second media content is not associated with DRM protections; and
upon determining the first sensitive information is being accessed via a second media content, transmitting at least one of the first alert to the DRM-protection system or a second alert to the user device.
